(19) United States
(12) Patent Application Publication
(10) Pub. No.: US 2025/0227260 A1
(43) Pub. Date: Jul. 10, 2025

(54) MOTION INFORMATION PARAMETERS PROPAGATION BASED ON INTRA PREDICTION DIRECTION

(71) Applicant: INTERDIGITAL CE PATENT HOLDINGS, SAS, Paris (FR)

(72) Inventors: Philippe BORDES, Laille (FR); Franck GALPIN, Thorigne-Fouillard (FR); Antoine ROBERT, Mézières sur Couesnon (FR); Guillaume BOISSON, Pleumeleuc (FR)

(21) Appl. No.: 18/853,599

(22) PCT Filed: Mar. 22, 2023
(86) PCT No.: PCT/EP2023/057365

§ 371 Date: Oct. 2, 2024

(30) Foreign Application Priority Data
Apr. 7, 2022 (EP) 22305471.9

(51) Int. Cl. H04N 19/176; H04N 19/139; H04N 19/159

(52) U.S. Cl. CPC H04N 19/176; H04N 19/139; H04N 19/159

(57) ABSTRACT

Methods and apparatus to fill in a motion information buffer with coding units or sub-blocks of coding units that are coded in intra mode comprise selection of neighboring inter prediction parameters into the motion information buffer using an intra prediction direction. In one embodiment, rescaling of inter prediction parameters is performed. In a variant, motion information such as motion vectors can be averaged or an affine model can be applied before storing of the parameters in a motion information buffer.

### CROSS REFERENCE TO RELATED APPLICATION

This application claims the benefit of EPO application Ser. No. 22/305,471.9, filed Apr. 7, 2022, which is incorporated by reference herein in its entirety.

### FIELD OF THE INVENTION

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY OF THE INVENTION

At least one of the present embodiments generally relates to a method or an apparatus for video encoding or decoding, and more particularly, to a method or an apparatus for improving the coding efficiency of intra prediction mode.

According to a first aspect, there is provided a method. The method comprises steps for copying available motion information from neighboring blocks into a buffer; selecting motion information from said buffer based on an intra mode for the video block; and encoding at least a portion of the video block using the selected motion information.

According to a second aspect, there is provided another method. The method comprises steps for copying available motion information from neighboring blocks into a buffer; selecting motion information from said buffer based on an intra mode for the video block; and decoding at least a portion of the video block using the selected motion information.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a generic video encoding or compression system.

FIG. 2 illustrates a generic video decoding or decompression system.

FIG. 3 illustrates examples of GPM predictions.

FIG. 4 illustrates an example of two GPM predictions and coarser storage parameters (dashed sub-blocks) in motion info buffers.

FIG. 5 illustrates storage of current CU coding intra mode information at sub-block precision in the IPM buffer.

FIG. 6 illustrates reference samples for intra prediction.

FIG. 7 illustrates (Left) intra prediction directions in HEVC and (Right) Intra prediction directions in VVC.

FIG. 8 illustrates wide angle intra prediction.

FIG. 9 illustrates an example of planar prediction mode.

FIG. 10 illustrates an example of motion information (MI) propagation direction derived from intra mode direction.

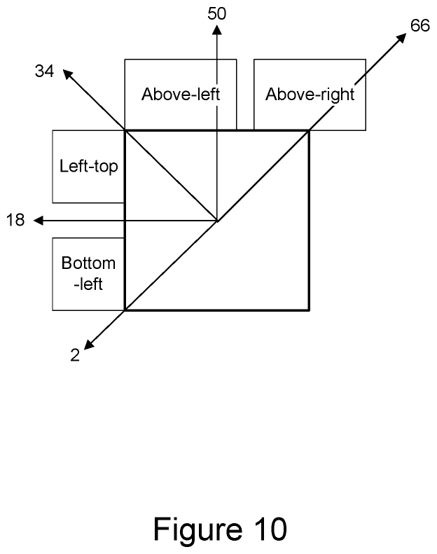

FIG. 11 illustrates an example of (a) 4 parameter affine model and (b) 6 parameter affine model.

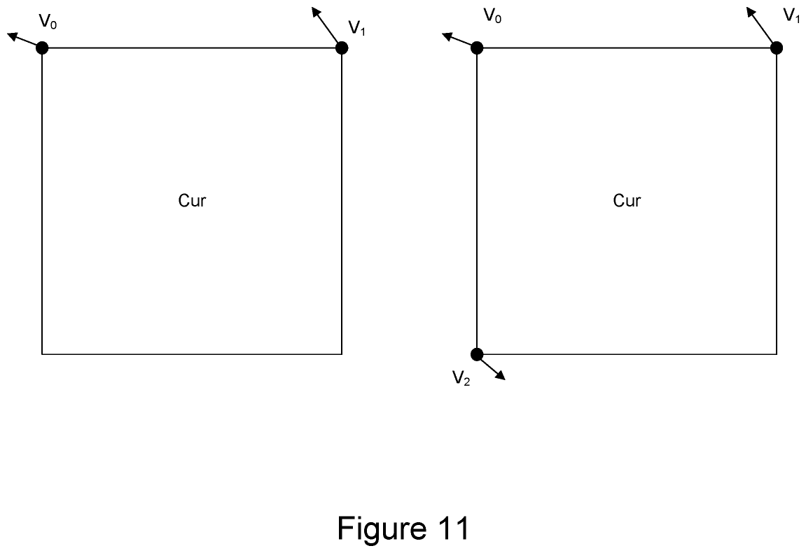

FIG. 12 illustrates a general synopsis of the described aspects.

FIG. 13 illustrates one embodiment of a method for performing the described aspects.

FIG. 14 illustrates another embodiment of a method for performing the described aspects.

FIG. 15 illustrates one embodiment of an apparatus for implementing the described aspects.

FIG. 16 illustrates a processor-based system for implementing the described aspects.

FIG. 17 illustrates another embodiment of a method for performing the described aspects.

FIG. 18 illustrates another embodiment of a method for performing the described aspects.

### DETAILED DESCRIPTION

The intra prediction is a fundamental coding tool in video compression. The encoder selects the best prediction mode and signals its index to the decoder to perform the same prediction. The intra prediction is performed using reference samples which are samples around the current block to decode already decoded. Currently, several modes are available in the VVC standard:
DC: uses reference samples to create a uniform prediction
planar mode: uses reference samples to create a smooth prediction of the block
directional modes: uses reference samples to “pad” these samples along a particular direction to create the prediction
MIP (Matrix based Intra Prediction): use a linear combination of the reference samples to create a prediction

All these modes use spatial information to create the prediction.

In inter coding, prediction is created using samples from one or more reference frames.

### Inter Mode Storage

In ECM codec, the motion information (MV values and reference indexes) used in inter modes to encode the CUs are stored in a buffer (MI buffer) which is associated with the current frame. It is stored with the reference pictures similarly to the decoder picture buffer (DPB). Then the motion information used to decode some samples in the reference picture are made available for the current picture. It can be used to build the list of MV neighbors candidates using MI buffer of the current frame or to get the co-located MV using MI buffer of the reference picture used as co-located reference (signaled in the slice or picture header).

### Intra Mode Propagation

In ECM codec, the intra modes used to encode the CUs in intra are stored in a buffer (IPM buffer) which is associated with the current frame. It is stored with the reference pictures similarly to the decoder picture buffer (DPB). Then the intra modes used to decode some samples in the reference picture are made available for the current picture. Both IPM and MI buffer can be combined (buffer containing both intra and inter information).

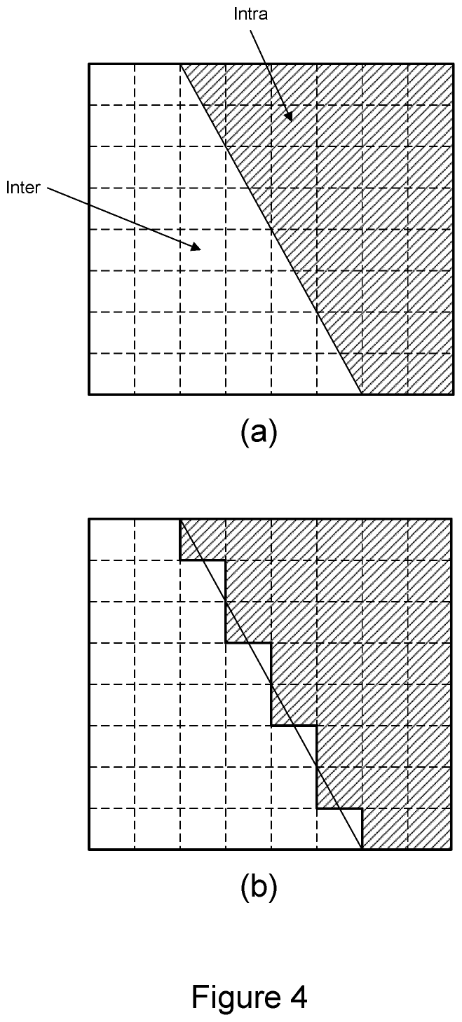

To reduce the storage amount, the information may be stored at coarser resolution than the current picture (ex: 4×4 resolution, FIG. 4). For example, if the ratio between the current picture size and the motion info is si=4, then the “MI” parameters of the block (or sub-block) located at (x,y) are stored at mi(x/4;y/4) in the motion info buffer.

In case the current CU is coded in inter uni-directional mode, the intra mode associated with the reference block (available through the IPM buffer associated with the reference picture) is copied into the IPM buffer of the current CU. In case the current CU is coded in inter bi-prediction mode, some rules (500) allow selecting the intra mode from the IPM buffer associated with the reference frame of list 0 (ref_0 from ipm0) or the reference frame of list 1 (ref 1 from ipm1):

| | | |
|---|---|---|
| if ref_0 is coded in intra and ref_1 coded in inter: | ipm0 | (510) |
| else if ref_0 is coded in inter and ref_1 coded in intra: | ipm1 | (520) |
| else if (ipm0 > DC_IDX && ipm1 <= DC_IDX): | ipm0 | (530) |
| else if (ipm0 <= DC_IDX && ipm1 > DC_IDX): | ipm1 | (540) |
| else if (pocDiff0 < pocDiff1): | ipm0 | (550) |
| else if (pocDiff1 < pocDiff0): | ipm1 | (560) |
| else if (QP-ref0 > QP-ref1): | ipm1 | (570) |
| else: | ipm0 | |

where: pocDiffX=pocRefX-pocCur, DC_IDX is the intra mode DC

Consequently, the intra mode information may be propagated temporally and is made available with all the reconstructed CUs. For the current CUs coded in intra, this information is furtherly used to build the list of most probable modes (MPM) with neighboring reconstructed CUs, even if they were coded in inter mode:
If CU neighbor is coded in intra, use the intra mode to build MPM list,
If CU neighbor is coded in inter, use the intra mode stored in the IPM buffer of the CU neighbor to build MPM list.
   Intra Mode Propagation with GPM with Inter and Intra Prediction

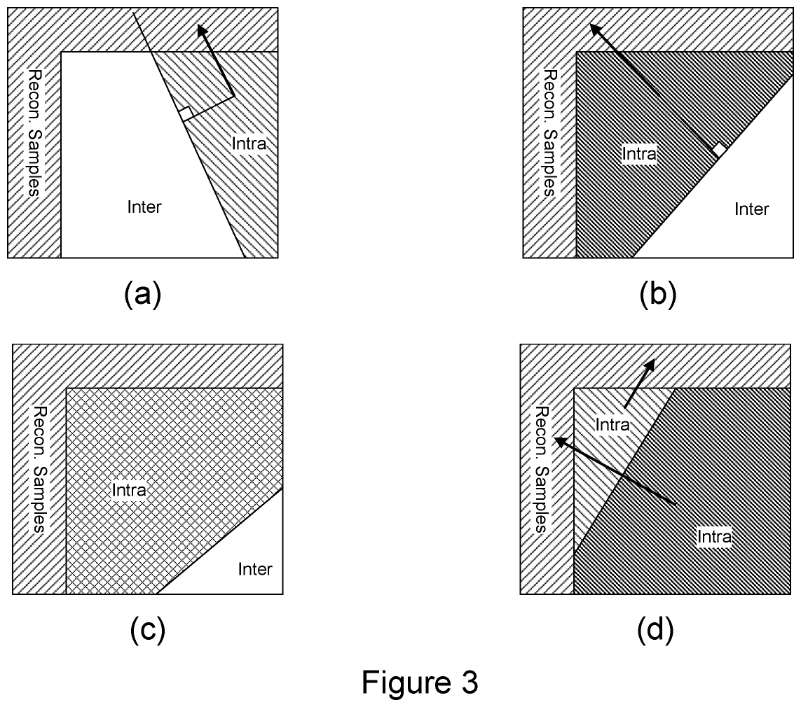

The geometric partitioning mode (GPM) allows predicting one CU with two non-rectangular partitioning as depicted in some examples in FIG. 3. Each partition may be Inter (275) or Intra (260). The samples of the inter partition are predicted with regular inter-prediction process, using motion compensated reference samples picked from one (uni-prediction) reference picture. The samples of the intra partition are predicted with regular intra prediction mode (IPM) and prediction process, where the available IPM candidates are the parallel angular mode against the GPM block boundary (Parallel mode), the perpendicular angular mode against the GPM block boundary (Perpendicular mode), and the Planar mode as shown FIG. 3 a-c, respectively.

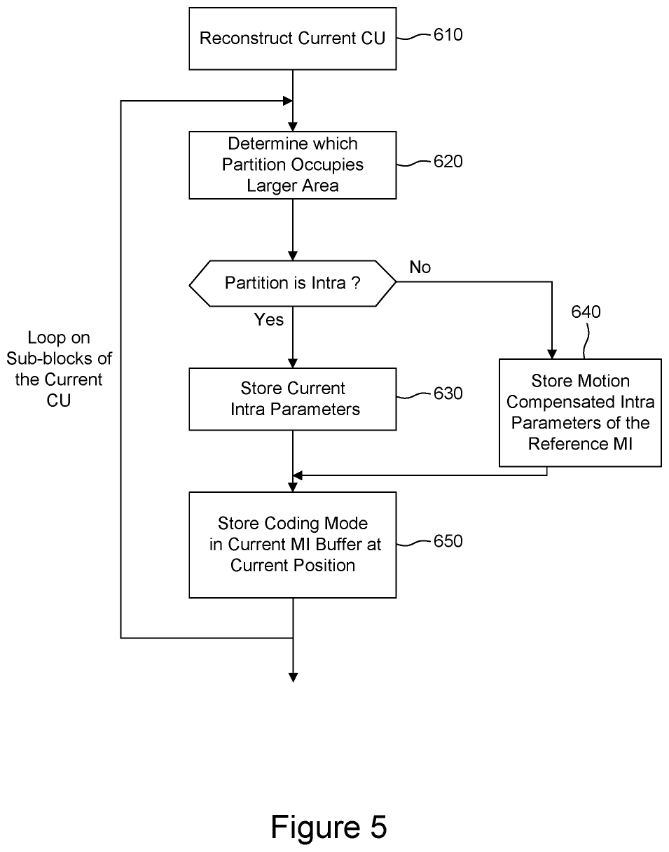

The motion vectors used to reconstruct the inter prediction part(s) and the IPM used to reconstruct the intra partition(s) are stored in the MI and IPM buffers respectively. In case of GPM, since the partition may be non-rectangular, for the sub-blocks shared by the two partitions, the stored information corresponds to the partition which occupies the larger area as depicted in FIG. 4 and FIGS. 5-620 (620).

For example, in FIG. 4 (a) the CU is predicted with one partition inter and one partition intra. The corresponding inter and intra parameters are stored in the MI and IPM buffers at 4×4 resolution FIG. 4 (b).

This information may be later used for coding subsequent CUs in the current picture and CUs in the subsequent pictures (in coding order), to predict the motion or the IPM to be used for example. Given a sub-blocks (x,y), if more samples are predicted with intra than in inter (620), the intra parameters are stored in the MI buffer (630). If more samples are predicted with inter than in intra (620), then the intra parameters are retrieved from the reference MI buffer, which is the MI buffer associated with the reference picture used for inter prediction. The location of the intra parameters is mi((x+mv_{X})/si,(y+mv_{Y})/si) (640), where (mv_{X}, mv_{Y}) is the motion vector of the inter prediction and si is the ratio between the current picture size and the motion info buffer size.

### Intra Prediction

The intra prediction process in HEVC and VVC consists of three steps:
Reference sample generation
Intra sample prediction and
Post-processing of predicted samples.

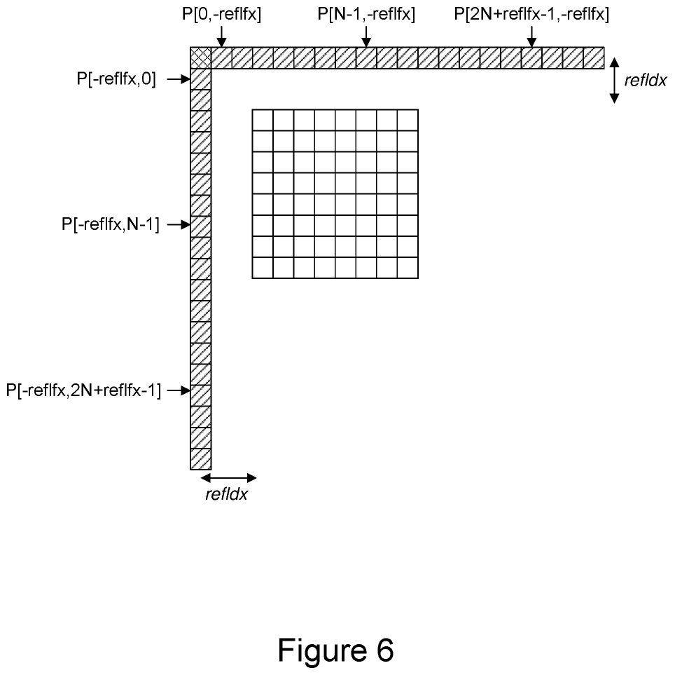

The reference sample generation process is illustrated in FIG. 6. The reference samples ref [ ] are also known as L-shape. For a prediction unit (PU) of size N×N, a row of (2N+refldx) decoded samples on the top is formed from the previously reconstructed top and top right pixels to the current PU. Similarly, a column of (2N+refldx) samples on the left is formed from the reconstructed left and below left pixels. In VVC, the reference line and column of samples may be distant (d=refldx) of more than one sample to the current block as depicted in FIG. 6.

The corner pixel at the top-left position is also used to fill up the gap between the top row and the left column references. If some of the samples on top or left are not available, because of the corresponding CUs not being in the same slice, or the current CU being at a frame boundary, etc., then a method called reference sample substitution is performed where the missing samples are copied from the available samples in a clock-wise direction. Then, depending on the current CU size and the prediction mode, the reference samples are filtered using a specified filter.

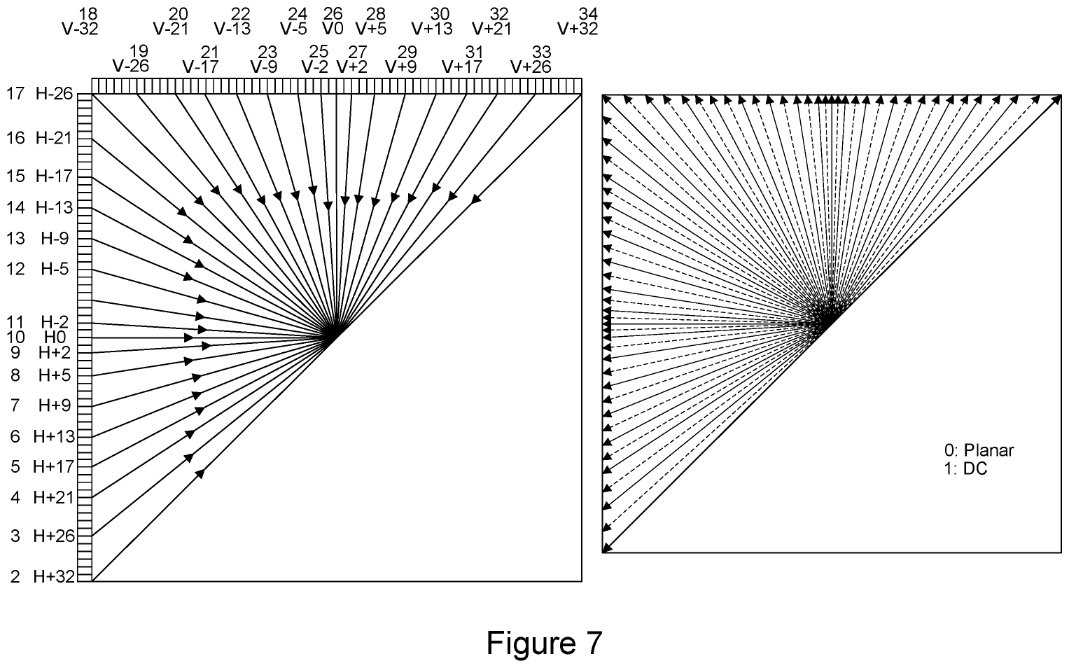

The intra sample prediction consists of predicting the pixels of the target CU based on the reference samples. There exist different prediction modes: Planar and DC prediction modes are used to predict smooth and gradually changing regions, whereas angular (angle defined from 45 degrees to −135 degrees in clockwise direction) prediction modes are used to capture different directional structures. For square blocks, HEVC supports 33 directional prediction modes which are indexed from 2 to 34. These prediction modes correspond to different prediction directions as illustrated in FIG. 7-left. In VVC, there are 65 angular prediction modes, corresponding to the 33 angular directions defined in HEVC, and further 32 directions each corresponding to a direction mid-way between an adjacent pair (FIG. 7, right).

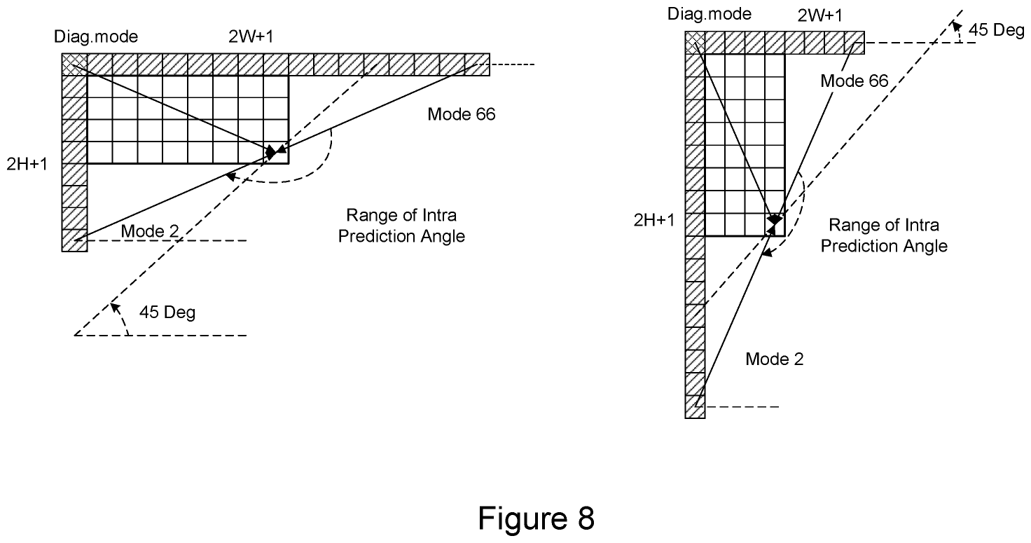

In VVC, for non-square blocks, the regular directional intra prediction which are not allowed (see FIG. 8) are replaced with additional wide-angle intra prediction modes.

For a given angular prediction mode, the predictor samples on the reference arrays are copied along the corresponding direction inside the target PU. Some predictor samples may have integral locations, in which case they match with the corresponding reference samples; the location of other predictors will have fractional parts indicating that their locations will fall between two reference samples. In the latter case, the predictor samples are interpolated using the nearest reference samples. In HEVC, a linear interpolation of the two nearest reference samples is performed to compute the predictor sample value; In WVC, for interpolating the predictor samples, 4-tap filters fT [ ] are used which are selected depending on the intra mode direction.

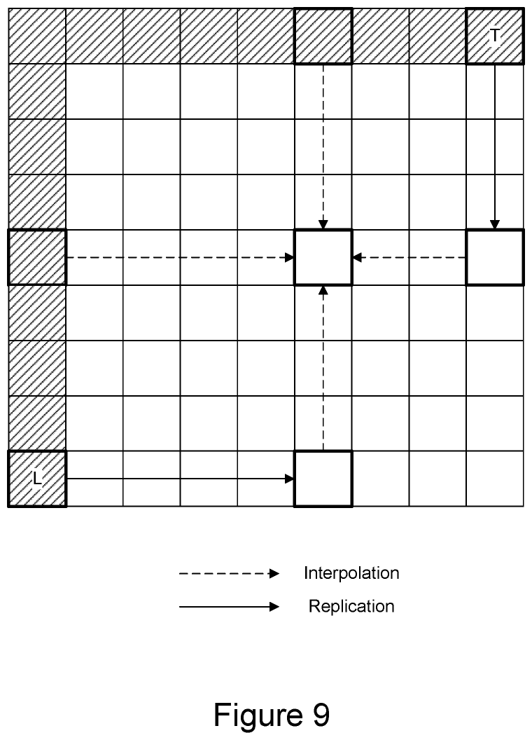

Besides directional modes, the DC mode fills-in the prediction with the average of the samples in the L-shape (except for rectangular CUs that use average of reference samples of the longer side), and the Planar mode interpolate reference samples spatially as depicted in FIG. 9.

The IPM buffer implement a propagation process allowing to fill-in information for all the CUs that may be coded in intra or in inter mode. However, such a mechanism does not exist for the motion info. In case of coding modes using motion information, this lack of data may negatively impact the coding efficiency.

It is proposed a motion information propagation process to fill-in the MI buffer in case of CUs (or sub-CUs) coded in intra mode.

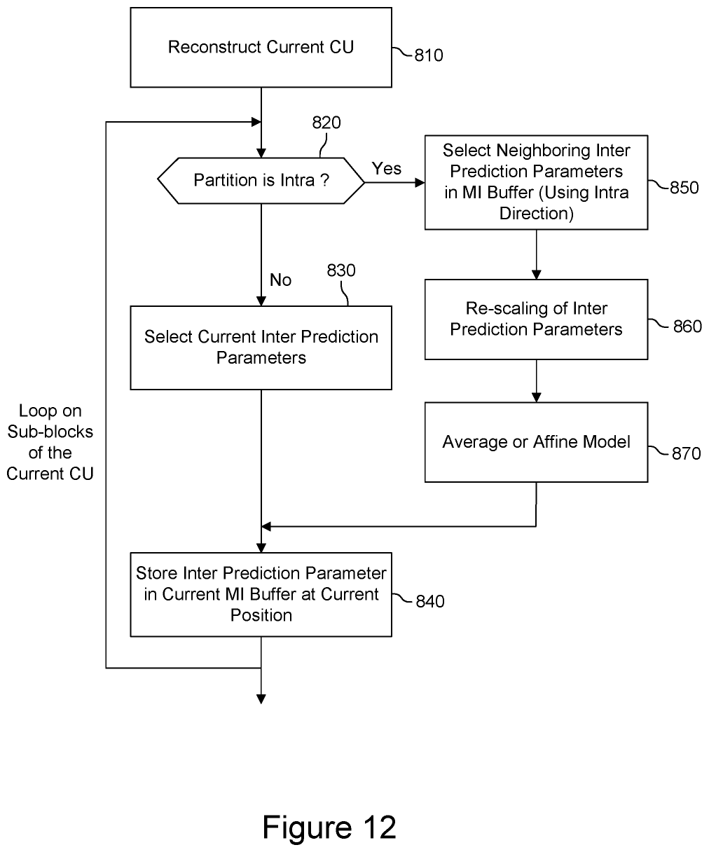

It is proposed some embodiments to propagate motion-info in case the current CU is coded in intra mode. The general synopsis of the method is depicted in FIG. 12. The method applies for the sub-block parts coded in intra in the current CU. The sub-block parts coded in inter uses the regular method (copy of the inter parameters in the current co-located MI buffer) (830 in FIG. 12). Some logical blocks of the synopsis in FIG. 12 may be not present, depending on the embodiments. Their function may vary depending on the embodiments/variants.

### Embodiment-1—Propagate Motion Info of Neighboring Blocks

The motion-info (MI) of a neighboring block is propagated into the MI buffer at the location of the current CU (current MI). A list of pre-determined neighboring block locations can be built. The first item of the list with MI available is selected (850) and copied into the current MI (840). For example, the list is all the reconstructed CUs on top of a current CU, from left to right, next, all the CUs at the left from top to bottom. In a variant, the neighboring CU with highest number of samples contiguous to the current CU is placed on top of the list. If two CUs have same MI, then they are considered as a same CU (number of contiguous samples are added).

The expression “MI is not available” may be defined as follows (several may be combined):
If current CU is at the picture border (or slice border, or tile border). If current CU is situated at the left border of the picture, then the left CU are not available.
If the neighboring CU has no MI data stored in its buffer, then it is not available.

In a variant, if the two first MI available in the list have same reference, then the motion vectors values can be averaged (870).

### Embodiment-2—Propagate Motion Info Along with the Intra Direction

In case of the current intra mode (predMode) is directional, the direction is used to select the location (850) of the MI to be propagated. For example, if the intra prediction uses samples from the top, the MI candidate to be propagated (miRef) is picked up from top CUs only.

In another example:
if (predMode<HOR_IDX (18))
   miRef=(Left-Bottom available)?mi(Left-Bottom): mi(Above-Left)·
else if (predMode<DIA_IDX (34))
   miRef=(Left-Top available)?mi(Left-Top): mi(Above-Left)·
else if (predMode<VER_IDX (50))
   miRef=(Above-Left available)?mi(Above-Left): mi(Left-Top)·
else//if (predMode<VDIA_IDX)
   miRef=(Above-Right available)?mi(Above-Right): mi(Left-Top)

In a variant, the MV values of several MI may be averaged (870) if they have same reference. For example:
if (predMode<HOR_IDX (18))
   if (Left-Bottom & Left-Top available and have same reference
      miRef=average {mi(Left-Bottom); mi(Left-Top)}
   else
      miRef=(Left-Bottom available)?mi(Left-Bottom): mi(Above-Left)
else if (predMode<DIA_IDX (34))
   if (Left-Top & Above-Left available and have same reference
      miRef=average {mi(Left-Top); mi(Above-Left)}
   else
      miRef=(Left-Top available)?mi(Left-Top): mi(Above-Left)·
else if (predMode<VER_IDX (50))
   if (Above-Left & Above-Right available and have same reference
      miRef=average {mi(Above-Left); mi(Above-Right)}
   else
      miRef=(Above-Left available)?mi(Above-Left): mi(Left-Top)·
else//if (predMode<VDIA_IDX)
   if (Above-Left & Above-Right available and have same reference
      miRef=average {mi(Above-Left); mi(Above-Right)}
   else
      miRef=(Above-Right available)?mi(Above-Right): mi(Left-Top).
In a variant, if a reference MI is available but doesn't have same reference, they can be re-scaled (860) using the POC of the reference so that they have same reference. One can chose the POC of the closest reference (pocRef) with the current frame as reference POC (pocCur).
miRescaled=miRef×(pocCur-pocRef)/(poc-pocRef)·
where: miRescaled, miRef are the value of the motion vector component X or Y.
poc is the POC of the miRef to be re-scaled.

### Embodiment-3—Propagate Motion Info with Affine Model

In case Bottom-Left, Above-Right and Left-Above are available, one may use Affine 6-parametric model to fill-in the MI buffer of the current CU with values that vary spatially (870). If they don't have same reference, MI re-scaling can be applied (see emb-2).

In a variant, one may use Affine 4-parameter model by selecting 2 reference MI using intra direction, in same way as emb-2.

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 y} - {mv}_{0 y}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

### Embodiment-4—Use Intra Reconstructed Samples to Estimate Motion Parameters to Propagate

According to this embodiment, the reconstructed samples of the current intra CU are used to estimate the best motion vector candidate to propagate. A list of motion vector candidates for the current CU is built using the regular list merge candidate building in same way as for a CU coded in inter merge mode. The cost of each candidate is evaluated using SATD with the reconstructed samples of the current coding unit. In a variant, to simplify the amount of calculation, the cost may be calculated using a reduced number of reconstructed samples (sub-part of the reconstructed CU samples). The candidate with minimal cost is selected to be propagated for the current CU.

In a variant, the Affine merge candidates are also evaluated.

### Embodiment-5—Propagated Motion Info not Used for Spatial Candidates

The embodiment 4 introduces additional latency since the propagation of the motion parameters should be done after the samples of the current CU have been reconstructed. Then the propagated motion parameters cannot be used for building the motion candidates for the next CU, unless waiting for their availability what may introduce additional latency. In this embodiment, the propagated motion information for the intra CU is not used for spatial candidates but for temporal candidates only. Advantageously (in a variant), the propagated motion information for the intra CU is not used for spatial candidates in case of embodiment 4 case only.

### Embodiment-6—Sub-Block Partitioning Propagation

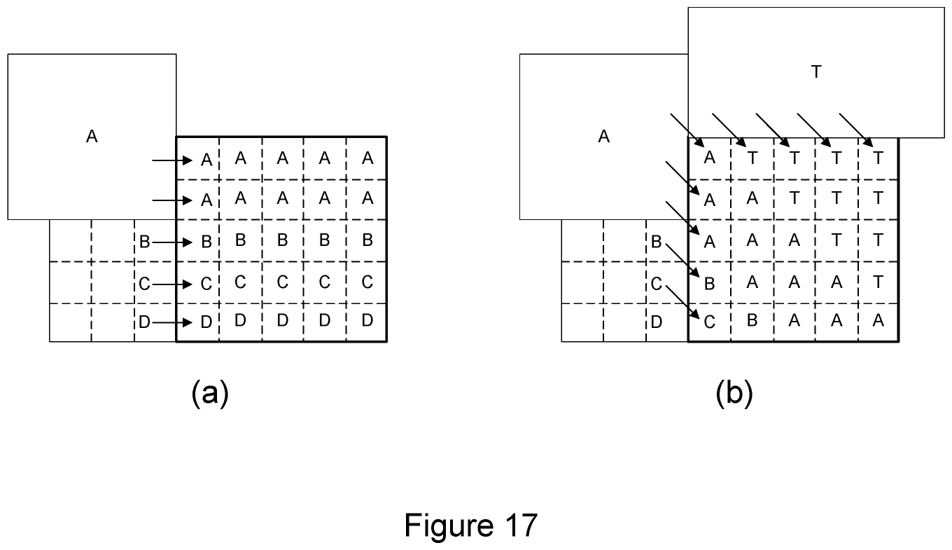

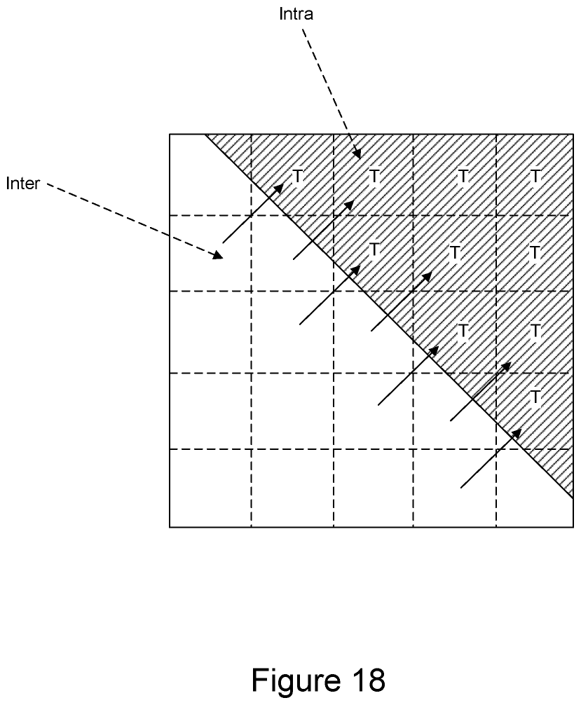

The MI propagation in the current intra block may be made per sub-block. For example, if the neighboring CU is made of sub-partitions, the MI parameters of each partition may be propagated in the current block as depicted in FIG. 17 examples for horizontal intra mode prediction direction (a) and diagonal intra mode prediction direction (b). In another variant, in case of GPM, the neighboring MI may be picked-up from the current CU, from the sub-partitions coded in inter as depicted in example of FIG. 18.

### Embodiment-7—Backward Propagation

In general, the prediction signal of the top and left samples of a block coded in intra mode are well correlated with the neighboring CU reconstructed samples. That is the reason why these neighboring CU reconstructed samples are used to build the intra prediction for the current CU. However, the other samples of the current CU (ex: right and bottom samples) may be less correlated with the neighboring (left and/or top) CU reconstructed samples. In this embodiment, if the current CU is coded in inter and one left (or top) neighboring CU has been coded in intra mode, then the MI parameters of the current CU may be propagated into the MI buffer associated with the neighboring (left or top) CU coded in intra.

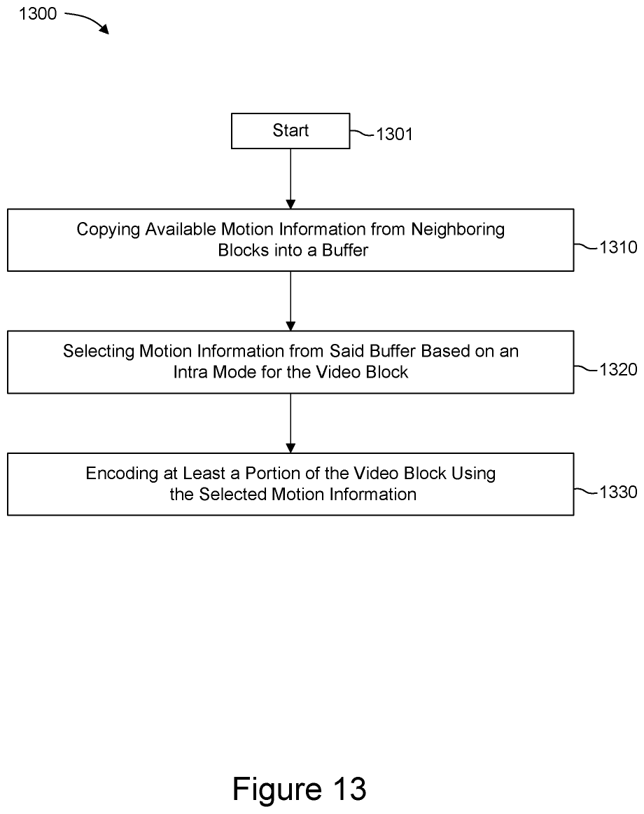

One embodiment of a method 1300 under the general aspects described here is shown in FIG. 13. The method commences at start block 1301 and control proceeds to block 1310 for copying available motion information from neighboring blocks into a buffer. Control proceeds from block 1310 to block 1320 for selecting motion information from said buffer based on an intra mode for the video block. Control proceeds from block 1320 to block 1330 for encoding at least a portion of the video block using the selected motion information.

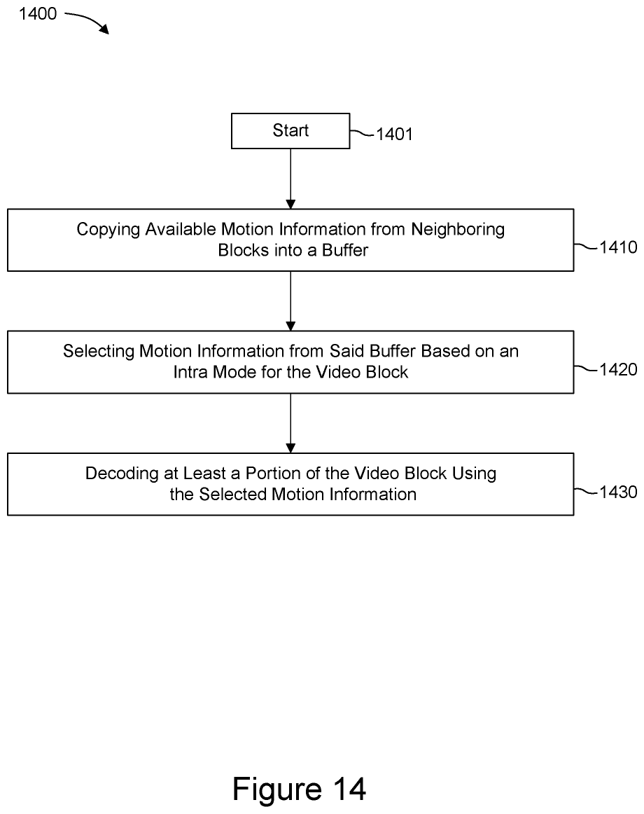

One embodiment of a method 1400 under the general aspects described here is shown in FIG. 14. The method commences at start block 1401 and control proceeds to block 1410 for copying available motion information from neighboring blocks into a buffer. Control proceeds from block 1410 to block 1420 for selecting motion information from said buffer based on an intra mode for the video block. Control proceeds from block 1420 to block 1430 for decoding at least a portion of the video block using the selected motion information.

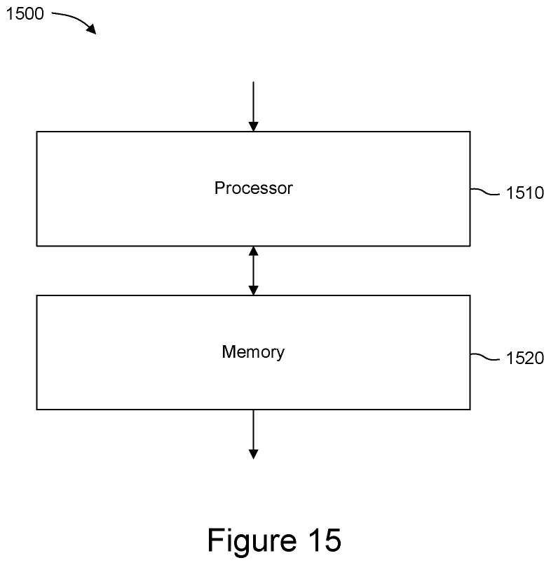

FIG. 15 shows one embodiment of an apparatus 1500 for encoding, decoding, compressing, or decompressing video data using any of the above methods, or variations. The apparatus comprises Processor 1510 and can be interconnected to a memory 1520 through at least one port. Both Processor 1510 and memory 1520 can also have one or more additional interconnections to external connections.

Processor 1510 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

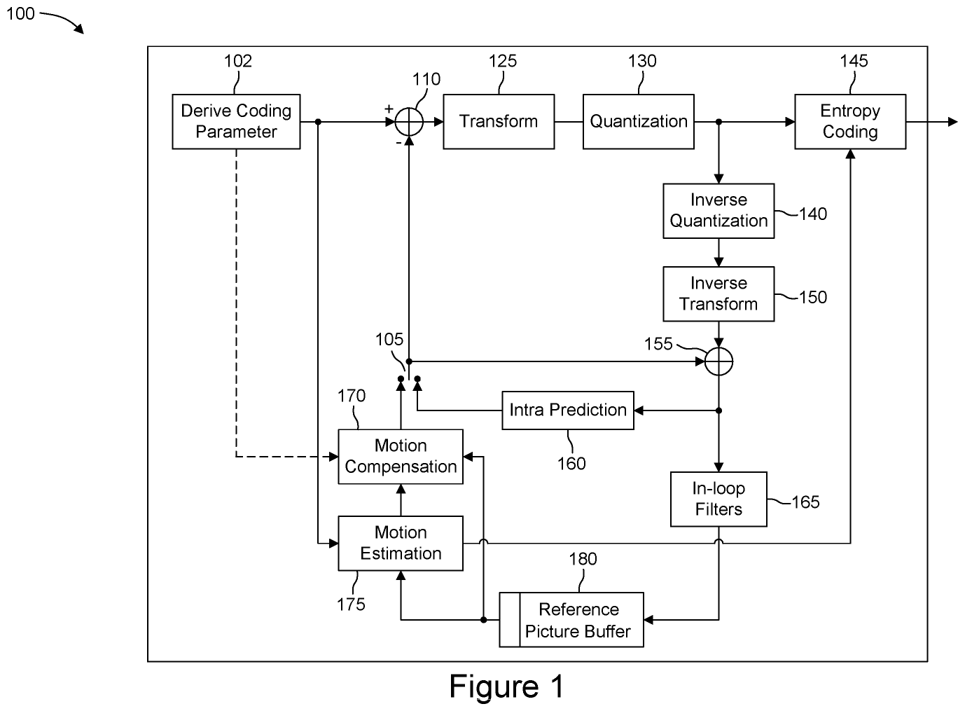

The aspects described and contemplated in this application can be implemented in many different forms. FIGS. 1, 2, and 16 provide some embodiments, but other embodiments are contemplated and the discussion of FIGS. 1, 2, and 16 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

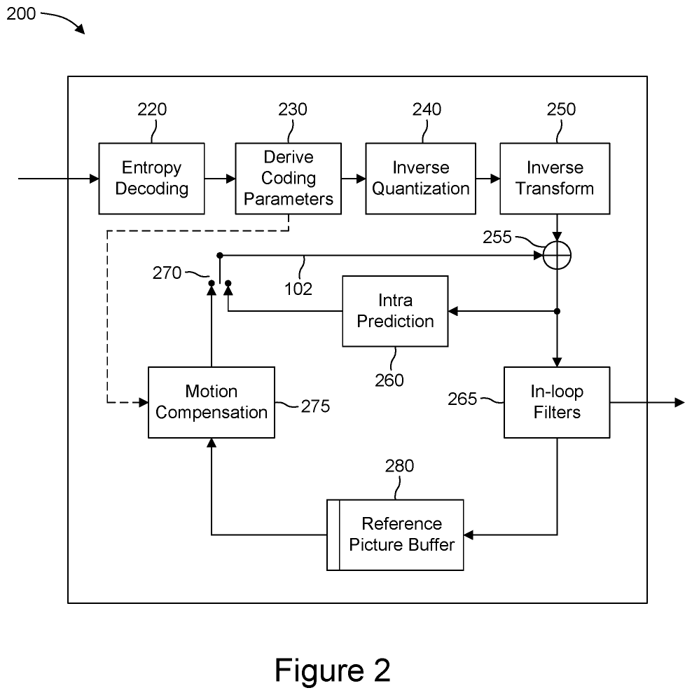

Various methods and other aspects described in this application can be used to modify modules, for example, the intra prediction, entropy coding, and/or decoding modules (160, 360, 145, 330), of a video encoder 100 and decoder 200 as shown in FIG. 1 and FIG. 2. Moreover, the present aspects are not limited to WVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 1 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset)/ALF (Adaptive Loop Filtering) filtering to reduce encoding artifacts. The filtered image is stored at a reference picture buffer (180).

FIG. 2 illustrates a block diagram of a video decoder 200. In the decoder 200, a bitstream is decoded by the decoder elements as described below. Video decoder 200 generally performs a decoding pass reciprocal to the encoding pass as described in FIG. 1. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

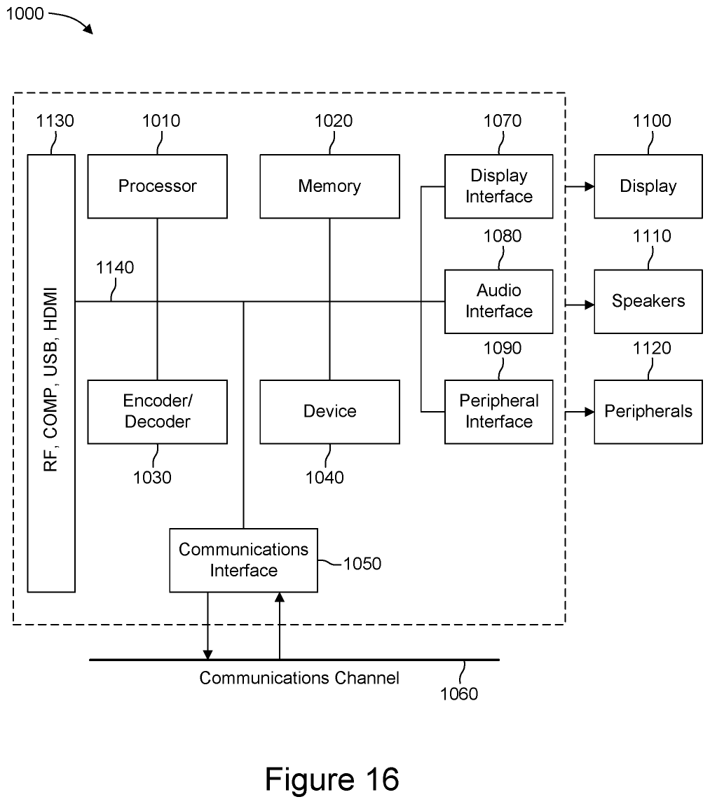

FIG. 16 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 16, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV. Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “ ”,“and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

One embodiment comprises copying motion information to a buffer from neighboring blocks to be used for intra coding/decoding a current video block.

One embodiment comprises using the above buffer information to code/decode a video block.

One embodiment comprises averaging the motion vectors from two or more motion information when they have identical references.

Other embodiments comprise any of the above methods wherein affine model comprises said motion information.

Other embodiments comprise any of the above methods wherein reconstructed samples of a current intra coded coding unit are used to estimate a motion vector candidate to propagate to the buffer.

One embodiment comprises a bitstream or signal that includes one or more syntax elements to perform the above functions, or variations thereof.

One embodiment comprises a bitstream or signal that includes syntax conveying information generated according to any of the embodiments described.

One embodiment comprises creating and/or transmitting and/or receiving and/or decoding according to any of the embodiments described.

One embodiment comprises a method, process, apparatus, medium storing instructions, medium storing data, or signal according to any of the embodiments described.

One embodiment comprises inserting in the signaling syntax elements that enable the decoder to determine decoding information in a manner corresponding to that used by an encoder.

One embodiment comprises creating and/or transmitting and/or receiving and/or decoding a bitstream or signal that includes one or more of the described syntax elements, or variations thereof.

One embodiment comprises a TV, set-top box, cell phone, tablet, or other electronic device that performs transform method(s) according to any of the embodiments described.

One embodiment comprises a TV, set-top box, cell phone, tablet, or other electronic device that performs transform method(s) determination according to any of the embodiments described, and that displays (e.g., using a monitor, screen, or other type of display) a resulting image.

One embodiment comprises a TV, set-top box, cell phone, tablet, or other electronic device that selects, bandlimits, or tunes (e.g., using a tuner) a channel to receive a signal including an encoded image, and performs transform method(s) according to any of the embodiments described.

One embodiment comprises a TV, set-top box, cell phone, tablet, or other electronic device that receives (e.g., using an antenna) a signal over the air that includes an encoded image, and performs transform method(s).

1. A method of encoding a video block, comprising:
copying available motion information from blocks into a buffer;
selecting motion information from said buffer based on an intra mode for the video block; and
encoding at least a portion of the video block using the selected motion information.

2. An apparatus, comprising:
a memory, and
a processor, configured to perform:
copying available motion information from blocks into a buffer;
selecting motion information from said buffer based on an intra mode for the video block; and
encoding at least a portion of a video block using the selected motion information.

3. A method, comprising:
copying available motion information from blocks into a buffer;
selecting motion information from said buffer based on an intra mode for the video block; and
decoding at least a portion of a video block using the selected motion information.

4. An apparatus, comprising:
a memory, and
a processor, configured to perform:
copying available motion information from blocks into a buffer;
selecting motion information from said buffer based on an intra mode for the video block; and
decoding at least a portion of a video block using the selected motion information.

5. The method of claim 1, wherein the motion information of a neighboring coding unit with highest number of samples contiguous to a current coding unit comprising the video block is placed in said buffer.

6. The method of claim 1, wherein motion vector values are averaged of two highest available motion information when said motion information comprises identical references.

7. The method or apparatus of claim 6, wherein a direction of a current intra mode is used to select location of the motion information to add to said buffer.

8. The apparatus of claim 4, wherein motion vector values are averaged of several available motion information when said motion information comprises identical references.

9. The apparatus of claim 4, wherein motion information of a reference is rescaled using a picture order count of another reference.

10. The apparatus of claim 2, wherein an affine parameter model is used to fill said buffer of a current coding unit with spatially varying values.

11. The apparatus of claim 4, wherein reconstructed samples of a current intra coded coding unit are used to estimate a motion vector candidate to add to said buffer.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of the video block.

13. A non-transitory computer readable medium containing data content generated according to the method of claim 1, for playback using a processor.

14. (canceled)

15. A computer program product comprising instructions which, when the program is executed by a computer, cause the computer to carry out the method of claim 3.

16. The method claim 3, wherein the motion information of neighboring coding unit with highest number of samples contiguous to a current coding until comprising the video block is placed in said buffer.

17. The method of claim 3, wherein motion vector values are averaged of two highest die motion information when said motion information comprises identical references.

18. The method of claim 17, wherein a direction of a current intra mode is used to select location of the motion information to add to said buffer.

19. The apparatus of claim 4, wherein motion vector values are averaged of several available motion information when said motion information comprises identical references.

20. The apparatus of claim 4, wherein motion information of a reference is rescaled using a picture order count of another reference.

21. The apparatus of claim 4, wherein an affine parameter model is used to fill said buffer of a current coding unit with spatially varying values.
